(19) United States
(12) Patent Application Publication
(10) Pub. No.: US 2026/0193053 A1
(43) Pub. Date: Jul. 9, 2026

(54) TESTING, MONITORING AND SERVICING THE PERFORMANCE/CONDITION OF A PASSENGER CONVEYING SYSTEM

(71) Applicant: Kone Corporation, Helsinki (FI)

(72) Inventors: Matti MUSTONEN, Helsinki (FI); Tom Lindstrom, Helsinki (FI); Tommi Nyberg, Helsinki (FI)

(73) Assignee: Kone Corporation, Helsinki (FI)

(21) Appl. No.: 19/429,746

(22) Filed: Dec. 22, 2025

(30) Foreign Application Priority Data
Jan. 9, 2025 (EP) 25150891.7

(51) Int. Cl. B66B 5/00; B66B 1/34

(52) U.S. Cl. CPC B66B 5/0037; B66B 1/3461; B66B 5/0018

(57) ABSTRACT

The invention is about the realisation of a method of testing and monitoring the performance of a passenger conveying system. A data acquiring unit is continuously gathering data of condition and/or performance of at least one system's component, a diagnostic unit is communicatively coupled to and configured to process the data as gathered by the acquiring unit, and a forwarding unit for communicating data with a cloud-computing-net, the method comprising the semi-automatic or full-automatic execution of the following computer implemented steps of determining by a remote computing unit a running sequence of operation of the system to execute at least one function of the system; Starting an operation action from the determined running sequence by means of the remote computing unit; Causing the acquiring unit to acquire measurement data specified to the operation action; Causing a transfer of the acquired data from the acquiring unit to the diagnostic unit; Causing a forwarding of processed data from the diagnostic unit to the cloud-net; Retrieving the processed data from the cloud-net; Analysing condition data by processing the retrieved data from the cloud-net; Issuing an analytical report that indicates the diagnosis result and making the report available for retrieval in the cloud-net.

### RELATED APPLICATIONS

This application claims priority to European Patent Application No. EP25150891.7 filed on Jan. 9, 2025, the entire contents of which are incorporated herein by reference.

### FIELD OF THE INVENTION

The present invention relates to the field of passenger conveyor technology. The invention in particular relates to a testing and/or monitoring of such conveying system by checking functional capability and operational quality of component(s) or sub-system(s) of the conveying system. At last, the present invention relates alternatively to computer-aided servicing the passenger conveyor system.

### BACKGROUND OF THE INVENTION

Any of those passenger conveyor systems may be considered in general as a distributed mechatronic system. Taking for example an elevator, the same includes an elevator car and possibly a counterweight, wherein the elevator car and the counterweight are suspended in an elevator shaft by suspension means or supported by any hydraulic mechanism. To such systems a plurality of mechanical and electrical components belongs, being arranged inter alia along the elevator shaft. Those elevator components may contribute in various elevator functions, such as guiding any elevator car movement in the elevator shaft, measuring an elevator car position, lighting an elevator system, suspending the elevator car, driving the elevator car, controlling the elevator system, transferring data within the elevator system and/or with an entity external to an elevator system, interfacing with an elevator user, ensuring safety of the elevator system and braking and/or arresting an elevator car movement, etc., Among such elevator components are elevator doors, door drive units, guiderails, fixing brackets, hoisting ropes, traction sheaves, electrical motors, encoders, bearings, lights, control nodes, user interfaces, data cables, cameras, position measurement targets for measuring an elevator car position, safety switches and safety contacts, safety brakes, control cabinets, electrical power units, and various other kind of sensors, actuators and structural components.

Having now a look to other passenger conveyor systems like escalators or auto-walks, a plurality of mechanical and electrical components is there also included even when being special for the single system, being for example arranged along the length of the escalator or auto-walk. All these components may contribute to various operational functions, such as guiding the movement of steps or pallets. Other components are handrails, step chains, drive chains, guide rails, balustrades, comb plates, traction systems, electrical motors, encoders, lights, control nodes, user interfaces, data cables, cameras, position measurement devices, safety switches and safety contacts, safety brakes, control cabinets, electrical power units, and various types of sensors, actuators, and structural elements. When commissioning such system after installation, a functional behaviour is carried out to ensure the system operates as intended. Usually, this test operation includes verifying that the system can operate at the desired speed and ride comfort, and that steps or pallets move seamlessly.

When, for example, comb plates or balustrades are assembled and attached to the structure, the drilling, positioning, and alignment of parts are typically done manually, leading to varying quality in a component operation. Although an installation check is carried out to confirm whether the newly installed components are within a functional range, the system may still exhibit operational variability due to differences in mounting situations.

After a technician has approved the basic functionality within a commissioning process, the conveying system is put into operation and then the maintenance monitoring starts, which evaluates when a component requires maintenance or replacement. Any installation must be maintained on regular basis to avoid malfunctions and reduce conveying system's downtime. Such malfunction may be caused by wear of any system's components, installation errors or defective components for example. Maintaining conveying systems can be laborious, requiring numerous site visits in large geographical areas by the maintenance personnel. Big portion of time spent consists of driving to the conveying system site and performing routine checks. Further, identifying and locating a component failure and accessing a failed component at site may be problematic and/or time consuming.

It is, however, not only about to correct a fault that is required to switch off the system. Elevators for example are sensitively critical for the people-flow in the building. It is not enough that an elevator moves up and down according to user requests, there is also a need to fulfill the necessary performance and people flow capacity requirements. If the elevator performance is not up to designed level due to e.g. non-optimal settings or less than 100% condition, it may cause significant impact to the people flow.

Currently, testing conveying system performance effectively requires specialized equipment and the presence of an expert onsite to execute and interpret the results. This process is labor-intensive and costly, limiting its application to rare and exceptional cases. As a result, comprehensive performance evaluations are seldom conducted, leaving many potential issues undetected until they manifest as significant operational failures.

While conveying system performance or condition can also be assessed through quick onsite tests—such as running the conveyor or running an elevator to various floors—this approach only identifies major malfunctions, such as the conveyor failing to move. It is incapable of detecting more subtle issues that can adversely affect the system's performance or the capacity of a system-group like elevator group to transport people efficiently. Such issues might include incorrect parameter settings for conveyor speed, or door speed at elevators, or optimization algorithms, which, while less apparent, can compromise the overall efficiency and service quality of the conveying system.

Taking elevators for example, these are equipped with numerous adjustable parameters, each of which influences performance. These parameters are typically configured with pre-defined factory settings, which can be fine-tuned onsite when necessary. However, adjusting these settings is a complex task, often avoided unless a clear and pressing issue arises. Consequently, many minor but impactful deviations in settings remain unaddressed, potentially reducing the elevator's optimal functionality and operational capacity.

### AIM OF THE INVENTION

It is an object of embodiments of the invention to address the above-identified drawbacks. In particular, it is an object of embodiments of the invention to raise the condition and performance quality of component(s) of a conveying system. Further, the maintenance work shall be simplified and maintenance results shall be improved.

### SUMMARY OF THE INVENTION

The above object is solved by the subject matter of the independent claims 1, 9, 12, 13 and 14 revealing a method of passenger conveying system performance testing, a method of monitoring such system, a computer program realizing the method steps, data carrier for the computer program and an conveyor system, respectively. The dependent claims relate to beneficial embodiments.

The invention shows a new approach that applies . . .
i) to continuously monitor a passenger conveying system remotely by a remote service unit
ii) to operate the conveying system from the remote service unit for a performance routine testing, and
iii) to analyse the conveying system's behaviour from the remote unit and
iv) if applicable or needed to remotely service the conveying system by means of adjusting parameters, updating software or changing data values of the system.

The inventive method of testing a passenger conveying system's performance involves utilizing a remote computing unit within a cloud network to monitor the performance by remotely applying testing operations. The passenger conveying system as a minimum basis consists of a control system with a controller configured to operate the conveyor, a data acquiring unit that continuously gathers condition and performance data of system components, a forwarding unit for communicating data with a cloud-computing-net, and a diagnostic unit designed to process or at least pre-process the acquired data. The method follows a semi-automatic or fully automated execution of the following computer-implemented steps that can be divided into four instance tools of
a remote test sequence generator,
a remote test sequence analyser,
a remote test sequence reporter and
optionally a remote test sequence scheduler.

With the advancements in passenger conveying system diagnostics, modern systems generate large amounts of data that can be used to test the condition of subsystems and components and it is precisely this data that is used in accordance with the invention to analyse the condition of any installed component of the passenger conveying system.

Remote Test Sequence Generator: The performance testing process itself originates from the tool of Remote Test Sequence Generator. The Remote Test Sequence Generator validates remote operation by checking availability, authorization, and safety and to then control the conveyor for the test run. Taking reference to for example elevator systems, these can generate elevator car calls to move the car to specified floors or to start actions like to open or close the doors. The system can run a sequence of car calls to visit all available floors while monitoring for local activity or pausing the sequence when needed. It possibly records progress and sends status updates, ensuring safe and efficient remote testing.

The testing process of Remote Test Sequence Generator in detail can begin with the remote computing unit checking any authorisation of the requestor. Such an authorisation encompasses i.a. the required allowance to get access for controlling the passenger conveying system at least in the specific range to carry out the method of the invention.

Then, a check is realized that is referenced to specific requirements for the conveying system under consideration. Some checks can be performed directly in the cloud, such as verifying the type of contract that is relevant with the customer or understanding customer preferences, like suitable times for testing. Other checks rely on real-time information from the conveying system itself, including its current mode or readings from devices, like a load-weighting system of an elevator.

Following to a positive outcome of this authorisation process, the method then involves the following sequence of automated steps, which are executed by the computing unit.

The method encompasses determining a running sequence of operations for the conveying system, identifying at least one function of the system to be executed. Once determined, the remote computing unit initiates an operation action based on the identified running sequence. Concurrently, the remote computing unit can access and can retrieve actual measurement data gathered by the data acquiring unit during the running sequence, ensuring that real-time information about the system's performance and condition is utilized. It is also possible to use earlier acquired measurement data that have been laid down in a memory and that can be useful to better classify the current measurement data—for example, to examine a historical process that has led to the current measurement data. For this purpose, the data acquiring unit can comprise a memory storing an amount of measurement data of the past.

As regards the above cited components as examples, like these are for an elevator system the elevator doors, door drive units, guiderails, fixing brackets, hoisting ropes, traction sheaves, electrical motors, encoders, bearings, lights, control nodes, user interfaces, data cables, cameras, position measurement targets for measuring an elevator car position, safety switches and safety contacts, safety brakes, control cabinets, electrical power units, and various other kind of sensors, actuators and structural components, there are components that can already provide data records per se, as a sensor is installed together with the respective component. The same is applicable for other conveying systems like handrails, step chains, drive chains, guide rails, balustrades, comb plates, traction systems, electrical motors, encoders, control nodes.

In the case of other components that do not have a device for providing data for the method according to the testing invention, it is advantageously possible to use sensors and couple them with the respective component, which serve to enable data to be read out on the functioning of the respective component, respectively.

The remote computing unit can also cause the acquiring unit to transfer the acquired measurement data as specified to the operation action to the diagnostic unit of the conveying system. These data are then pre-processed in the diagnostic unit and are then first retrieved by the remote computing unit via the cloud. As an alternative, this solution can be also mixed with retrieving both, i.e. pre-processed data from the diagnostic unit of the conveying system along with measurement data as acquired by the acquiring unit. This then also enables to evaluate actual measure results with earlier acquired measurement data that have been laid down in a memory and that can be useful to better classify the current measurement data—for example, to examine a historical process that has led to the current measurement data. For this purpose, the data acquiring unit can comprise a memory storing an amount of measurement data of the past.

The controlled operation actions can deviate from running modes of the component under normal use having the advantage that special test sequences can be run through.

These can provide better and more detailed information about the functionality of the component by means of the special measurements obtained therewith as compared to tests under normal operation, only. Said operation sequence for running the component under consideration in special manner can according to an embodiment also include to embed this operation sequence by coupling the same with other entities. For example, the function of opening and closing a door of an elevator can be embedded in the process of an elevator car arriving at a particular floor. The measurement data for the door movement, which is then used to evaluate the functionality of the door for commissioning the door or a part of it, is therewith embedded in the process of the elevator car movement, which ends with the arrival of the car at a certain floor.

Importantly, the underlying principle is that no action involving safety risks is executed by the conveying system, even if requested from the cloud. Safety-critical checks, such as ensuring the safety chain is open and preventing conveyor movement in such cases, are always performed onsite. Safety is guaranteed through two types of checks. First, static or semi-static characteristics are verified, including whether the requester is authorized, whether the contract allows remote operations, whether local regulations permit such operations, and whether the requested operation is supported by the conveying system's hardware and software. Second, dynamic conditions of the equipment are assessed, ensuring that the conveying system's mode allows remote operations (e.g., not permitted in firefighting mode or when the test switch is activated) and whether tenants do use the conveying system, wherein the latter takes priority over test sequences if someone attempts to use the conveying system during testing. These checks are conducted both in the cloud and within the device itself to ensure safety is never compromised, even in rare corner cases. There is no additional communication needed between the equipment and the cloud network; all checks can be based on the conveying system's master data, contract information, and the normal 24-hour-a-day telemetry data provided by the equipment.

The system can record the progress of the test sequence and send status messages accordingly. These status messages serve multiple purposes. First, they track and document the progress of the test in real time, providing detailed updates. Taking again the example of an elevator system this can involve like “moved to the 2nd floor, ok,” “doors opened, ok,” “doors closed, ok,” or “moved to the 3rd floor, ok.” This ensures that any issues preventing the elevator from completing the full test sequence can be pinpointed by identifying the last successful step. Additionally, status messages are crucial for reporting the real-time status of the test sequence, particularly during manual test execution, while also serving as a record of the test execution and its results. These records can be reviewed later for analysis, troubleshooting, or for further reporting purposes.

Remote Test Sequence Analyser: The retrieved measurement data and/or the pre-processed data of the conveying system is/are then read out and analysed by the tool Remote Test Sequence Analyser that is implemented on the remote computing unit.

According to a preferred embodiment, the diagnostic unit as present on the conveying system site pre-processes/processes the data by setting parameter values from the measurement values and also setting corresponding limit values, establishing therewith a desired performance range for the specific operation action as initiated, a benchmark that represents acceptable operating conditions for the component. By setting these values, the system can detect deviations that may signify potential issues in alignment, installation quality, or component wear. The diagnostic unit then evaluates the extent to which the acquired data do fall within or exceed these predefined performance limits, providing insights into any deviations from expected operational standards.

As an alternative, the diagnostic unit of the conveying system represents only part of the overall diagnostic unit which is further present in part in the cloud computing and also in part on the remote site. The diagnostic unit of the conveying system pre-processes the acquired data and transfers these pre-processed data to the cloud computing for forwarding to a final processing to the diagnostic unit that is remote and directly connected to the computing unit that encompasses the other computing tools of the Remote Test Sequence Generator, the Remote Test Sequence Analyser, the Remote Test Sequence Reporter, and the Remote Test Sequence Scheduler.

Summing up, the above tool of the Remote Test Sequence Analyser monitors conveyor components and actions and/or functions of such components by evaluating the processed data, possibly pre-processed in a diagnostic unit at the system's site, and collects long-term statistical data to identify aging impacts.

Remote Test Sequence Reporter: Based on this analysis, the diagnostic unit generates an analytical report according to the next tool of a Remote Test Sequence Reporter that indicates the results of evaluation. This report is made available for retrieval in the cloud network, allowing a maintenance service center to access detailed performance data and insights regarding the conveying system's operation. The solution allows for generating different reports from the same test, tailored to various purposes. For customers, the report can showcase the condition of their equipment and provide transparency on the actions performed. For authorities or inspectors, it can serve as evidence of the equipment's condition and demonstrate compliance, particularly in cases where visits are replaced by such reports. Technicians benefit from detailed information about the conveying system's current and past conditions, aiding maintenance efforts or troubleshooting. Additionally, the report can include specific guidance or instructions on resolving potential issues. The test sequence itself can trigger separate service needs, which include detailed information about the issue and instructions for necessary repairs.

Internally, a cloud-view report can provide a comprehensive overview of the test sequence, including results, successfully visited floors (elevator, escalator) even accounting for locked floors, any faults encountered, travel time to floors (elevator, escalator), door operation times (elevator), and energy consumption. Externally, a customer-facing report can be derived from this internal data, presenting information in a simplified manner, such as the time the test was executed and its overall OK/NO-OK status, or offering more detailed insights if desired. When failures or anomalies are detected, service needs can be automatically generated, complete with all necessary information and repair instructions to ensure swift resolution.

This method ensures continuous, efficient, and accurate monitoring of the conveying system, supporting proactive maintenance and optimal system performance. The Remote Test Sequence Reporter visualizes overall test sequence results and related movement data, focusing on faults or deviations, and i.a. can generate printable reports (e.g., PDF) summarizing the test sequence.

The invention holds a distinct competitive advantage by identifying conveying system condition issues before they become visible to customers and users. This proactive approach not only ensures uninterrupted service but also enhances customer satisfaction by preventing disruptions. Additionally, the invention's ability to measure, influence, and demonstrate the impact of actions on conveying system performance sets it apart from prior art. By showcasing measurable improvements and tangible outcomes, the invention strengthens maintenance efforts as a trusted solution for optimizing elevator operations.

This proactive and performance-driven approach leads to a higher-value maintenance. Furthermore, this solution reinforces the invention's image as the leading innovation in delivering superior people flow solutions.

There are different scenarios triggering the above performance testing method. The condition and performance of an conveying system must be thoroughly evaluated to ensure the system operates effectively and reliably. Performance testing can be triggered by various events, including periodic checks, such as annual inspections, continuous monitoring, customer inquiries about performance, or parameter changes applied to the conveying system. In cases of continuous monitoring according to the present invention, the conveying system regularly transmits telemetry data to the cloud.

Remote Test Sequence Scheduler: According to an embodiment of the invention, there is a Remote Test Sequence Scheduler as a tool that automates and optimizes the test execution. It initiates tests based on
schedule-based rules (e.g., daily, weekly, monthly)
and/or condition-based triggers (e.g., fault codes, service needs),
and/or AI-driven insights (e.g., complex patterns and fault relations).

The Remote Test Sequence Scheduler is a highly advanced tool designed to remotely initiate and manage the diagnostic tests with precision and adaptability. It operates through a versatile mechanism that leverages scheduled routines, dynamic condition-based triggers, and advanced AI-driven insights. These functionalities can work independently or synergistically, ensuring optimal responsiveness and efficiency across a variety of operational scenarios.

At its core, the scheduler can initiate tests based on predefined schedules, enabling routine maintenance and monitoring with exceptional consistency. For instance, daily testing ensures that critical systems are constantly validated, while weekly schedules strike a balance between operational demands and the need for diagnostics. Monthly tests cater to systems with lower failure probabilities, providing periodic assessments without unnecessary interruptions. This schedule-based approach offers predictability and ensures adherence to maintenance protocols or regulatory standards, fostering reliable performance over time.

Failed or interrupted tests can be re-scheduled automatically, and a batch execution ensures any load balancing. Manual initiation or intervention is also possible and supported for maintenance tasks, providing a versatile and efficient solution for managing test operations.

In addition to or alternatively to its regular schedules, the scheduler can be equipped to react dynamically to real-time operational data, initiating tests whenever specific conditions are met. This includes scenarios such as the detection of fault codes, where diagnostic tests are triggered automatically to address potential issues promptly. Similarly, when service thresholds, such as mileage limits or component wear levels, are reached, the scheduler initiates targeted tests to pre-empt failures. Moreover, it can respond to unusual events, such as performance anomalies or environmental stressors, ensuring that systems remain responsive and resilient under changing conditions.

Further, a test sequence can be performed automatically after a call-out has been reported for an equipment component. This allows the system to automatically execute a predefined test sequence whenever a call-out, indicating an issue or malfunction, is reported for a specific equipment component. The call-out may be triggered by automated fault detection systems, user reports, or remote monitoring identifying irregularities. Following the call-out, the system initiates the test sequence to diagnose the issue, validate the malfunction, and identify the root cause. This sequence is tailored to the reported fault and involves operational checks and simulations to assess the component's functionality. By adapting to real-time circumstances as above described, this condition-based functionality optimizes resource allocation and ensures timely interventions.

According to this alternative, the present invention also includes an independent preceding continuous monitoring process before applying the above testing process-steps: The above testing method then follows a previous routine method of monitoring a conveying system that involves configuring the conveyor controller to regularly transmit telemetry data from the acquiring unit and/or diagnostic unit to the cloud for being accessible by the computing unit of the remote service system. The computing unit analyses the retrieved telemetry data by comparing the conveying system's performance metrics—such as waiting times, ride durations, and passenger throughput—with a reference population of conveyors that share similar configurations. If the analysis reveals that the conveyor's performance is significantly slower than its peers, the system automatically recommends conducting a testing as described above to identify and address potential issues.

These continuously retrieved data are processed by an algorithm leading to distinguish between issues arising from suboptimal parameter settings and those caused by functional or condition-related deficiencies. It also verifies the customer's value preferences and any special requirements. These inputs allow the algorithm to determine whether the conveying system's performance aligns with customer expectations and whether the parameters are optimally configured to meet those needs. The algorithm then evaluates results by comparing the conveying system's metrics with the reference population.

Based on the results, the algorithm delivers one of several outcomes.
i) If the conveying system is running in optimal condition, no further actions are needed.
ii) If the conveying system's performance is suboptimal due to its used parameters or running software version, the algorithm analyses parameter optimization or software updating. It is then analysed by the diagnostic unit whether it is possible to automatically adjust a parameter for performance optimisation and/or updating software. If so, this is done by the remote computing unit causing the conveying system controller to automatically amend the respective values/parameter or to send those or a software update from a cloud computing unit to the conveying system controller for implementation. After new parameters, values or software is uploaded, the elevator controller is then caused to verify the changes through simulation or further performance tests according to the above described inventive maintenance method.

Alternatively, if the parameters are correct but performance issues persist, the system will issue a warning for reduced conveying system condition, identifying potential causes and providing actionable recommendations to improve the system's performance at site.

Enhancing its capabilities further, the scheduler can incorporate artificial intelligence to analyse complex datasets and uncover insights that drive predictive diagnostics. It recognizes recurring patterns and links seemingly unrelated faults, revealing root causes that traditional methods might overlook. This predictive capability enables proactive testing, where potential failures are forecasted and addressed before they impact operations. AI-driven analysis thus elevates the scheduler's ability to anticipate risks and mitigate them, reducing downtime and enhancing overall system reliability.

The true strength of the tool of Remote Test Sequence Scheduler lies in its ability to combine these functionalities seamlessly. Scheduled routines can be augmented by real-time condition-based triggers, ensuring comprehensive monitoring that adapts to both predictable cycles and unexpected events. Dynamic triggers can further leverage AI insights to address deeper, more complex issues with precision. When schedules are enriched with AI-driven data, routine checks become more targeted and effective, focusing attention on critical areas that require intervention. This integrative approach makes the scheduler a robust and adaptive framework for diagnostics, ensuring conveying systems remain in optimal condition and minimizing disruptions caused by unplanned downtime.

The conveying system performance analysis relies on a robust set of interconnected databases one of which is i.a. the storage database of the diagnostic unit. The conveying system parameter database stores all current and historical parameters for each conveyor or conveyor group. The conveying system performance database maintains records of all performance tests, linking them to the corresponding parameter settings. A recommended parameters database contains a curated set of optimal configurations for various conveying system setups, updated dynamically based on real-world testing. Finally, the conveying system usage pattern database aggregates raw and processed data on the usage patterns of individual conveyors or conveyor groups. This database enables the definition of relevant performance tests tailored to each situation and the calculation of the practical impacts of specific performance levels. In view of elevator this could mean achieving in 95% a waiting time of less than 30 seconds under particular settings.

All algorithms used for analysis may rely on expert-defined rules, Artificial Intelligence (AI), or generative AI technologies, leveraging advanced data processing techniques to deliver precise and actionable insights.

In the following, an elevator system as the passenger conveying system is taken as an example being described for the inventive method and being supported by a drawing in which

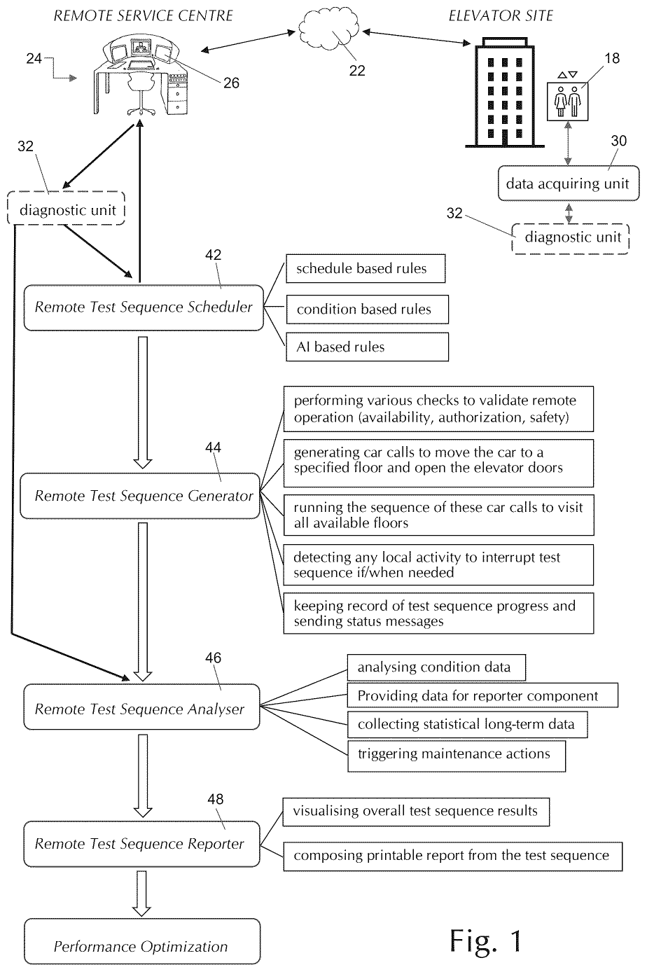

FIG. 1 shows a flow sheet of processing steps according to the invention.

Let one assume that the system performs a permanent monitoring as realized by the Remote Test Sequence Scheduler 42 tool. The scheduler can initiate tests based on predefined schedules, enabling routine maintenance and monitoring with exceptional consistency. In addition to its regular schedules, the scheduler is equipped to react dynamically to real-time operational data, initiating tests whenever specific conditions are met. This includes scenarios such as the detection of fault codes, where diagnostic tests are triggered automatically to address potential issues promptly. Similarly, when service thresholds, such as mileage limits or component wear levels, are reached, the scheduler initiates targeted tests to pre-empt failures. Moreover, it can respond to unusual events, such as performance anomalies or environmental stressors, ensuring that systems remain responsive and resilient under changing conditions. By adapting to real-time circumstances, this condition-based functionality optimizes resource allocation and ensures timely interventions. Regardless of whether a monitoring result has indicated a malfunction by “condition based rules” or whether a time period has simply expired by “scheduled based rules”, or whether “AI based rules” gave an insight in operation of an elevator at building site, the Remote Test Sequence Scheduler 42 tool outputs a result that triggers the performance test using the Remote Test Sequence Generator 44 tool to perform various checks to validate remote operation (availability, authorisation, safety).

The remote computing unit is first checking any authorisation of the requestor. Such an authorisation encompasses i.a. the required allowance to get access for controlling the elevator system at least in the specific range to carry out the method.

Then, a check is realized that is referenced to specific requirements for the elevator under consideration. Some checks can be performed directly in the cloud, such as verifying the type of contract that is relevant with the customer or understanding customer preferences, like suitable times for testing. Other checks rely on real-time information from the elevator itself, including its current mode or readings from devices like the load-weighting system.

Following to a positive outcome of this authorisation process, the method begins with the remote computing unit 26 like one of a remote service centre 24 determining a running sequence for the elevator system 18 at the elevator building site to test any condition or specific performance or to test a general performance. This sequence specifies the necessary steps to execute at least one designated function of the system. Once determined, the remote computing unit 26 initiates an operation action in accordance with the predefined sequence. This initiation triggers the acquiring unit 30 to capture measurement data tailored to the specific operation being performed.

The performance test phase starts with the elevator being driven to the second-lowest landing, ensuring the test begins from a mid-level position within the system's range. The elevator then travels downward to the lowest landing, executing automatic door operations, including opening and closing sequences. Precise data on door movement dynamics, such as speed, alignment, and force metrics, is collected during this phase. The elevator subsequently moves upward, stopping at each landing it serves to perform door operations, gathering consistent performance data across all floors. This sequence is repeated multiple times—typically five cycles—to ensure statistical confidence and minimize data inconsistencies caused by anomalies.

In parallel, the elevator conducts multiple trips between terminal floors to collect additional operational data, such as electrical balance and energy consumption.

Throughout these movements, the acquiring unit 30 continuously collects the required data of the operation action, respectively, which is transferred to the diagnostic unit 32 of the elevator system 18 for processing. The diagnostic unit 32 refines the data, forwarding it to the cloud-net for centralized storage and accessibility.

Telemetry messages containing car status updates, door and fault events, and responses to remote commands are thus transmitted from the diagnostic unit 32 of the elevator system 18 to the cloud 22 and the cloud-based remote computing unit 26.

Upon completing the test sequences, the system transitions to post-test data analysis by the Remote Test Sequence Analyser 46 tool. This phase involves aggregating telemetry data and daily statistics with historical performance metrics stored in the central diagnostic database. The combined dataset is analysed in near-real time using advanced algorithms and AI-driven insights. This analysis evaluates operational trends, detects anomalies, and generates diagnostic outputs, including fault occurrence analysis and specific component performance evaluations. Furthermore, the system is designed to assess the severity and urgency of identified issues, enabling it to generate and send notifications such as a ‘Service Need.’ These notifications are tailored based on the analysis results and can specify whether immediate attention by a technician is required (‘now’) or if the issue can be addressed during the next scheduled maintenance visit. This feature enhances the operational efficiency of the system by ensuring timely responses to critical faults while optimizing maintenance scheduling for non-urgent issues, thereby reducing downtime and improving overall system reliability.

Based on this analysis, an analytical report is generated by the Remote Test Sequence Reporter 48 tool. This report includes according to a convenient embodiment comprehensive findings such as average operational metrics, performance trends, and diagnostic insights. The report is made available in the cloud-net for authorized retrieval and review. A remote technician accesses the commissioning report via a secure cloud interface to assess the elevator's performance and determine whether adjustments, such as parameter tuning or software updates, are needed. If necessary, the system communicates specific optimizations for a technician, such as modifying speed parameters or reconfiguring door timings.

If the elevator's performance is suboptimal due to its used parameters or running software version, the algorithm analyses parameter optimization or software updating. It is then analysed by the diagnostic unit whether it is possible to automatically adjust a parameter for performance optimisation and/or updating software. If so, this is done by the remote computing unit causing the elevator controller to automatically amend the respective values/parameter or to send those or a software update from a cloud computing unit to the elevator controller for implementation. After new parameters, values or software is uploaded, the elevator controller can then be caused to verify the changes through simulation or further performance tests. Alternatively, if the parameters are correct but performance issues persist, the system will issue a warning for reduced elevator condition, identifying potential causes and providing actionable recommendations to improve the system's performance at site.

Once adjustments are implemented, additional test sequences verify their effectiveness in resolving identified issues, ensuring optimal system performance.

This iterative process ensures the elevator system's functionality, safety, and efficiency, while the cloud-net integration provides a seamless platform for data analysis, reporting, and performance optimization.

This process is designed to be flexible and adaptable to various elevator configurations and operational requirements. Depending on the condition data analysed, certain steps in the sequence may be adjusted, skipped, or added. For instance, if initial telemetry data reveals a recurring door alignment issue at specific floors, the system can incorporate additional door operation tests at those locations to pinpoint the problem. Advanced algorithms, powered by AI or generative AI technologies, ensure that the analysis is both accurate and efficient, identifying root causes and providing actionable insights.

By automating routine condition checks and enhancing predictive maintenance, this solution reduces the need for on-site technician visits, streamlining the maintenance process and lowering operational costs. Furthermore, it enables technicians to focus on critical tasks that demand their expertise, boosting productivity and minimizing elevator downtime. The system ensures faster, more systematic, and widespread resolution of potential issues, resulting in optimized operational efficiency and improved customer satisfaction.

### REFERENCE NUMERALS

Elevator system 18
Net computer cloud 22
Remote service centre 24
Remote computing unit 26
Acquiring unit 30
Diagnostic unit 32
Remote Test Sequence Scheduler 42
Remote Test Sequence Generator 44
Remote Test Sequence Analyser 46
Remote Test Sequence Reporter 48

1. A method of testing the performance and/or condition of a passenger conveying system, the system comprising a controller configured to operate the conveyor, a data acquiring unit that is continuously gathering data of condition and/or performance of at least one system component, a diagnostic unit communicatively coupled to and configured to process the data as gathered by the acquiring unit, and a forwarding unit for communicating data with a cloud-computing-net, the method comprising the semi-automatic or full-automatic execution of the following computer implemented steps for testing the operation of the conveying system by means of a remote computing unit that is part of a cloud-net:
Determining by the remote computing unit a running sequence of operation of the conveying system to execute at least one function of the system;
Starting an operation action from the determined running sequence by means of the remote computing unit;
Causing the acquiring unit to acquire measurement data specified to the operation action;
Causing a transfer of the acquired data from the acquiring unit to the diagnostic unit;
Causing a forwarding of processed data from the diagnostic unit to the cloud-net;
Retrieving the processed data from the cloud-net;
Analysing data by processing the retrieved data from the cloud-net; and
Issuing an analytical report that indicates the diagnosis result and making the report available for retrieval in the cloud-net.

2. Method according to claim 1, wherein the method comprises
Processing the data by the diagnostic unit by setting one or more parameter values, and setting corresponding limit values for the parameter values, respectively, and defining therewith a desired performance range for the operated action as started;
Determining by the diagnostic unit the extent to which the acquired measurement data extend the defined performance range beyond the one or more limit values;

3. Method according to claim 1, wherein the remote computing unit belongs to a remote maintenance center being communicatively coupled in the cloud net.

4. Method according to claim 1, wherein at least one step of the automated method is outsourced to be processed by a further cloud computing unit communicating with the elevator controller.

5. Method according to claim 1, wherein an analysis of the acquired measurement data is supported by an algorithm of AI (Artificial Intelligence) using a trained machine-learning unit aiding in calculating the determination result.

6. Method according to claim 2, wherein an analysis of the acquired measurement data is supported by an algorithm of AI (Artificial Intelligence) using a trained machine-learning unit aiding in setting the one or more limit values.

7. Method according to claim 1, wherein the analytical report indicating the determination result is analysed in view of whether the conveying system indicating a parameter extending the desired performance range can be adapted by updating a software or software component or by setting an operation value differently such that the parameter under consideration can be accordingly brought into the desired performance range.

8. Method according to claim 6, wherein comprising the servicing step of remotely installing new parameter values or new software or a software component to adapt the parameter extending the desired performance range.

9. Method according to claim 1, wherein the method is automatically computer-aided triggered by schedule-based rules, so-to-say e.g., daily, weekly or monthly.

10. Method of monitoring the performance of an passenger conveying system, the system comprising a controller configured to operate the conveyor, a data acquiring unit that is continuously acquiring data of condition and/or performance of at least one system component, a diagnostic unit communicatively coupled to and configured to process the data as gathered by the acquiring unit, and a forwarding unit for communicating data with a cloud-computing-net, wherein the controller is configured to regularly transmit telemetry data from the acquiring unit and/or from the diagnostic unit to the cloud, the data being retrievable by a remote computing unit of a remote maintenance center, wherein the retrieved telemetry data are analysed by the remote computing unit with reference to a condition-based trigger, like fault codes or service needs.

11. Method according to claim 9, wherein the retrieved telemetry data are analysed by comparing the system's performance metrics, such as waiting times, ride durations, and the number of passengers transferred, with standard metric data arising from a reference population consisting of other conveyors in similar configurations, wherein if the system's performance is notably slower than its peers, the system issues a recommendation for a maintenance performance test.

12. Method according to claim 9, wherein the analysis is supported by AI-driven insights, analysing therewith complex patterns and/or fault relations.

13. A computer program resident on a computer-readable media and comprising a set of instructions arranged to cause a computer, or a suite of computers, to perform the computer implemented method steps of claim 1.

14. A non-transitory computer readable medium storing the computer program according to claim 12 for executing the computer implemented steps for auditing the operation of the at least one installed component by means of a computing unit.

15. System comprising
A passenger conveying system that comprises at least an conveyor along with a plurality of further components, an acquiring unit configured to acquire measurement data of at least one of the system's components, which data are corelated to a condition and/or operation of the at least one component, a diagnostic unit communicatively coupled to the acquiring unit for processing the measurement data, a forwarding unit for communicating the measured data of the acquiring unit and/or the processed data of the diagnostic unit with a cloud-net for retrieval the data of the forwarding unit in the cloud, and a conveyor controller configured to operate the conveyor, wherein the system further comprises
A remote computing unit that is part of the cloud-net, wherein the remote computing unit is configured to:
Determine a running sequence of operation of the passenger conveying system to execute at least one function of the system;
Start an operation action from the determined running sequence for the at least one component;
Cause the acquiring unit to acquire measurement data specified to the operation action of the at least one component;
Cause a transfer of the specified acquired data from the acquiring unit to the diagnostic unit;
Cause a forwarding of processed data from the diagnostic unit to the cloud-net;
Retrieve the processed data from the cloud-net;
Analyse condition data of the at least one component based on the retrieval of the processed data; and
Issue an analytical report as a result from the analysis that indicates the diagnosed condition result based on the operation action and making the report available for retrieval in the cloud-net.

16. System according to claim 14, wherein the diagnostic unit is configured to
Process the data by setting one or more parameter values, and setting corresponding limit values for the parameter values, respectively, and defining therewith a desired performance range;
Determining the extent to which the acquired measurement data extend the defined performance range beyond the one or more limit values; and
Issuing an analytical report indicating the determination result and making the report available for retrieval in the cloud-net.
